(19) United States
(12) Patent Application Publication
(10) Pub. No.: US 2009/0128300 A1
(43) Pub. Date: May 21, 2009

(54) WIRELESS DEVICE WITH AN RFID INTERROGATOR

(75) Inventor: Rick C. Lake, Boise, ID (US)

Correspondence Address: GREENBERG TRAURIG, LLP (SV3), IP DOCKETING, 2450 COLORADO AVENUE SUITE 400E, SANTA MONICA, CA, 90404, US

(73) Assignee: Keystone Technology Solutions, LLC

(21) Appl. No.: 11/942,390

(22) Filed: Nov. 19, 2007

(51) Int. Cl. H04B 7/00

(52) U.S. Cl. 340/10.3

(57) ABSTRACT

A wireless device includes an antenna, a radio unit, a signal processing unit, a control unit and a radio frequency identification (RFID) interrogator having a programmable memory. The programmable memory is programmed to interrogate an RFID device located within a discrete range from the RFID interrogator at user-selectable time intervals and to generate an alert upon loss of a return signal to the RFID interrogator when the RFID device is out of the discrete range.

### BACKGROUND

The present invention relates to wireless devices, and more particularly to a wireless device with a radio frequency identification (RFID) interrogator.

RFID is a technology that incorporates the use of electromagnetic or electrostatic coupling in the radio frequency (RF) portion of the electromagnetic spectrum to uniquely identify an object, animal, or person. With RFID, the electromagnetic or electrostatic coupling in the RF (radio frequency) portion of the electromagnetic spectrum is used to transmit signals. A typical RFID system includes an antenna and a transceiver, which reads the radio frequency and transfers the information to a processing device (reader) and a transponder, or RF tag, which contains the RF circuitry and information to be transmitted. The antenna enables the integrated circuit to transmit its information to the reader that converts the radio waves reflected back from the RFID device into digital information that can then be passed on to computers that can analyze the data.

### BRIEF DESCRIPTION OF THE DRAWINGS

FIG. 1 is a block diagram of an exemplary wireless device.

FIG. 2 is a block diagram of an exemplary RFID interrogator.

FIG. 3 is a block diagram of an exemplary RFID device.

FIG. 4 is a flow diagram.

Like reference numbers and designations in the various drawings indicate like elements.

### DETAILED DESCRIPTION

The present invention provides methods and apparatus for a wireless device with an RFID interrogator.

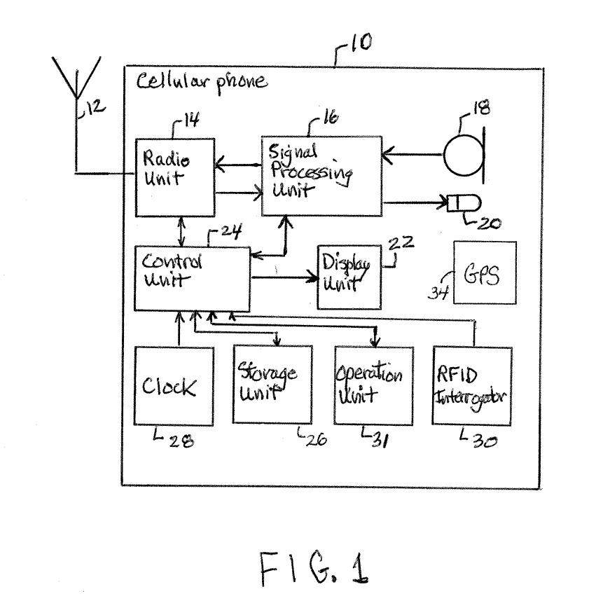

As shown in FIG. 1, an exemplary wireless device 10 includes an antenna 12, a radio unit 14 and a signal processing unit 16 that performs processing, such as coding and decoding. The wireless device 10 includes a microphone 18, a speaker 20, a display unit 22, a control unit 24 and a storage unit 26 that stores a telephone directory and various settings. The wireless device 10 includes a clock circuit 28, an RFID interrogator 30 (also referred to as an RFID reader), an operation unit 31; the control unit 24 controls these units. The cellular device 10 may also include an optional Global Positioning System (GPS) unit 34. Example wireless devices include cellular telephones, wireless-enabled personal digital assistants (PDAs), wireless-enabled GPS units, and so forth.

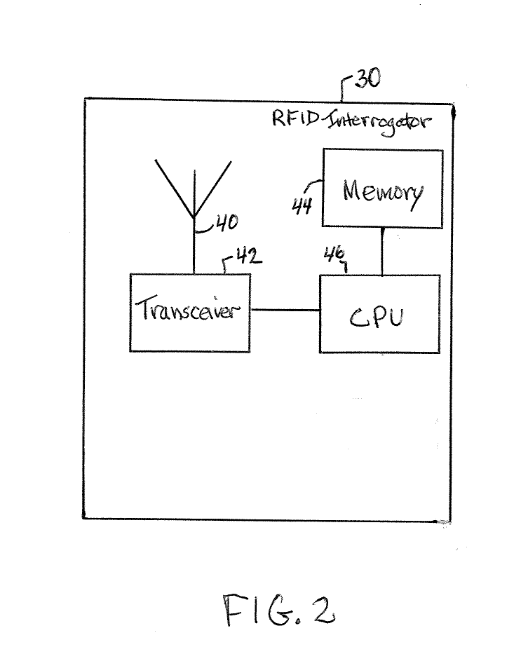

As shown in FIG. 2, the RFID interrogator 30 includes an antenna 40, a transceiver 42, a programmable memory 44 and a processor 46. The RFID interrogator 30 is programmable and performs Time Division Multiplexing (TDM) with the transceiver 42 and antenna 40. Data downloaded from an RFID device can be stored in memory 44.

RFID devices are broadly categorized as passive RFID devices and active RFID devices. In general, a passive RFID device is an RFID device that does not contain a battery; the power is supplied by the RFID interrogator. When radio waves from the RFID interrogator are encountered by a passive RFID device, the antenna within the RFID device forms a magnetic field. The RFID device draws power from it, energizing the circuits in the RFID device. The RFID device then sends the information encoded in the RFID device's memory to the RFID interrogator.

In general, an RFID device is an active RFID device when it is equipped with a battery that can be used as a partial or complete source of power for the device's circuitry and antenna. Some active devices contain replaceable batteries for years of use; others are sealed units.

There are almost endless possible uses for RFID labeling. For example, labels can be with embedded RFID labels. In one example, a RFID device is a pressure-sensitive device with an RFID transponder (inlay) embedded between the device face stock and its release liner. This RFID device can be encoded with large amounts of variable information that can be gathered by an RFID interrogator.

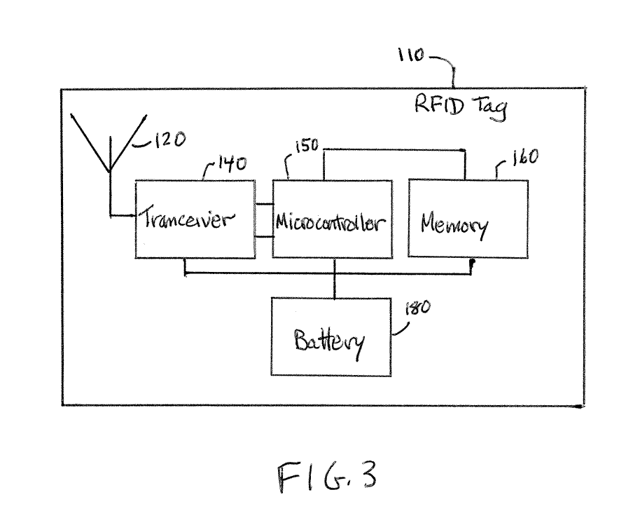

As shown in FIG. 3, an exemplary RFID device 110 (also referred to as a RFID tag) includes an antenna 120, transceiver 140, microcontroller 150, memory 160 and in some configurations, a battery 180. When triggered by RF interrogation via transceiver 140, microcontroller 150 fetches the data (e.g., time stamp, unique RFID code and so forth) from memory 160 and sends it out to the interrogator, such as RFID interrogator 14, as multiplexed data packets from transceiver 140.

RFID devices like RFID device 110 can be placed on or in any number of items, such as credit/debit cards and the like, automobile/motorcycle keys, house keys and the like, wireless email devices such as Blackberry, Palm and the like, portable radios, CD players and/or MP3 players and the like, and so forth.

The RFID interrogator 30 can be programmed to interrogate RFID tags, like RFID device 110, located within a discrete range. The interrogator 30 can also be programmed to generate a notification or alert upon loss or absence of a return signal when one or more of the RFID devices goes out of range. Alerts can be received by the control unit 24 and a user notified through an audio indication, a visual indication, a vibration, or any combination thereof. In one example, the interrogator 30 can be programmed to generate a unique alert for a particular RFID device.

The interrogator 30 can be programmed to poll one or more RFID devices at user-selectable intervals of time. For example, the interrogator 30 can be programmed to poll a RFID device residing in a credit card more often than a RFID device residing in a vehicle key.

Received alerts can be paused and/or terminated. Received alerts can be assigned priorities, e.g., loss of a signal from a RFID device in a credit card can take priority over loss of a signal from a RFID device in an MP3 player.

Alerts sent by the interrogator 30 include an RFID device code identifying the object that is no longer responding to its interrogation, and may include a time, date and/or GPS coordinates (if the wireless device 10 includes the optional GPS unit 34).

Having the interrogator 30 included in the wireless device 10 enables the user to be informed or alerted when any of the RFID devices are out of range or fail to respond to an interrogation.

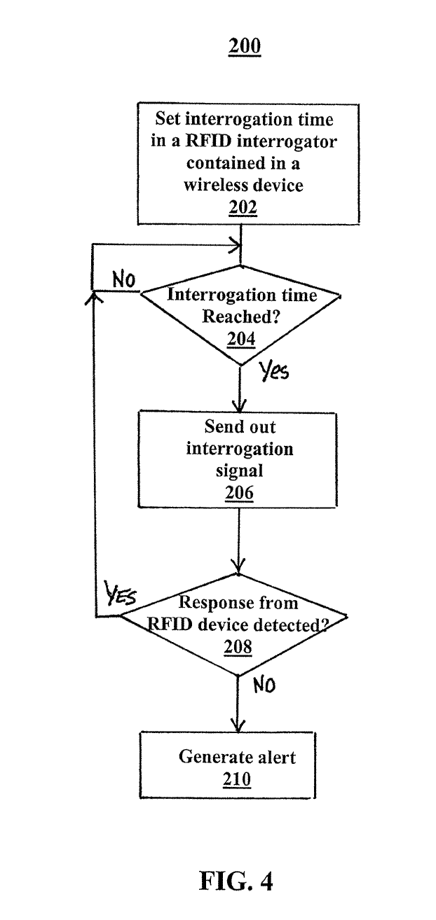

As shown in FIG. 4, a process 200 includes setting (202) an interrogation time in an interrogator contained in a wireless device.

Process 200 determines (204) whether the interrogation time is reached. If the interrogation time is reached, process 200 sends (206) out an interrogation signal.

Process 200 determines (208) whether a RFID device has responded to the interrogation signal. If the RFD device fails to respond to the interrogation signal, process 200 generates (210) an alert in the wireless device. The alert can be a visual indication, an audio indication, a physical indication such as a vibration, or a combination of indications.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

It is to be understood that the foregoing description is intended to illustrate and not to limit the scope of the invention, which is defined by the scope of the appended claims. Other embodiments are within the scope of the following claims.

What is claimed is:

1. A method comprising:
in a wireless device having a radio frequency identification (RFID) interrogator, generating an alert when an RFID device that the RFID interrogator is programmed to interrogate is out of a discrete range.

2. The method of claim 1 wherein the alert is an audio indication.

3. The method of claim 1 wherein the alert is a visual indication.

4. The method of claim 1 wherein the alert is a physical indication.

5. The method of claim 1 wherein the RFID interrogator is programmed to interrogate the RFID device at user-selectable intervals of time.

6. The method of claim 1 further comprising suspending the alert in response to a user input.

7. A method comprising:
in a wireless device having a radio frequency identification (RFID) interrogator, generating an alert when any one of a plurality of RFID labels that the RFID interrogator is programmed to interrogate is out of a discrete range.

8. The method of claim 7 wherein the alert is an audio indication.

9. The method of claim 7 wherein the alert is a visual indication.

10. The method if claim 7 wherein the alert is a physical indication.

11. The method of claim 7 wherein the RFID interrogator is programmed to interrogate the RFID labels at user-selectable intervals of time.

12. The method of claim 7 wherein the alert is user-prioritized for the RFID device.

13. The method of claim 7 further comprising suspending the alert in response to a user input.

14. A wireless device comprising:
an antenna;
a radio unit;
a signal processing unit;
a control unit; and
a radio frequency identification (RFID) interrogator, the RFID interrogator programmed to interrogate an RFID device located within a discrete range from the RFID interrogator at selectable time intervals and to generate an alert upon loss of a return signal when the RFID device is out of the discrete range.

15. The wireless device of claim 14 further comprising:
a microphone;
a speaker;
a display unit;
an operation unit;
a storage unit; and
a clock circuit.

16. The wireless device of claim 14 further comprising a Global Positioning System (GPS) unit.

17. The wireless device of claim 14 wherein the RFID interrogator comprises:
an antenna;
a transceiver; and
a processor.

18. The wireless device of claim 14 wherein the RFID device comprises:
an antenna;
a transceiver;
a microcontroller; and
a memory including a device identification.

19. The wireless device of claim 18 wherein the RFID device further comprises a battery.

20. The wireless device of claim 14 wherein the alert is an audio indication.

21. The wireless device of claim 14 wherein the alert is a visual indication.

22. The wireless device of claim 14 wherein the alert is a physical indication.

23. The wireless device of claim 14 wherein the alert comprises a time at which the return signal was lost.

24. The wireless device of claim 16 wherein the alert comprises GPS coordinates at the time at which the return signal was lost.
